(19) United States
(12) Patent Application Publication
(10) Pub. No.: US 2016/0239313 A1
(43) Pub. Date: Aug. 18, 2016

(54) CONTROL OF ROUTER IN CLOUD SYSTEM

(71) Applicant: EMPIRE TECHNOLOGY DEVELOPMENT LLC, Wilmington, DE (US)

(72) Inventor: Shuichi KURABAYASHI, Fujisawa-shi (JP)

(21) Appl. No.: 14/384,979

(22) PCT Filed: Nov. 8, 2013
(86) PCT No.: PCT/US13/69162

§ 371 Date: Sep. 12, 2014

(51) Int. Cl. G06F 9/44; H04L 12/931; H04L 12/933

(52) U.S. Cl. CPC G06F 9/4416; H04L 49/15; H04L 49/20

(57) ABSTRACT

Technologies are generally described for a scheme for controlling rebooting process of computing nodes. In some examples, a method performed under control of a router connected between a storage and a computing node may include receiving a signal that initiates a rebooting process of the computing node; enabling an FPGA (Field-Programmable Gate Array) to transmit at least one packet; and transmitting the at least one packet from the storage to the computing node based at least in part on a predefined FPGA program that is stored in the FPGA.

### BACKGROUND

The term “cloud computing” refers to computing models for enabling ubiquitous, convenient, or on-demand network access to a shared pool of configurable computing resources (e.g., networks, servers, storage, applications, or services). Cloud-based services are rapidly becoming the primary way in which services are provided to businesses and consumers over the Internet and the World Wide Web.

### SUMMARY

In an example, a method performed under control of a router connected between a storage and a computing node includes receiving a signal that initiates a rebooting process of the computing node; enabling an FPGA (Field-Programmable Gate Array) to transmit at least one packet; and transmitting the at least one packet from the storage to the computing node based at least in part on a predefined FPGA program that is stored in the FPGA.

In another example, a router connected between a storage and a computing node includes an FPGA configured to transmit at least one packet from the storage to the computing node based at least in part on a predefined FPGA program that is stored in the FPGA; and a switch configured to: receive a signal that initiates a rebooting process of the computing node, and enable the FPGA to transmit the at least one packet.

In yet another example, a computer-readable storage medium may store thereon computer-executable instructions that, in response to execution, cause a router to perform operations including receiving a signal that initiates a rebooting process regarding a computing node; enabling an FPGA to transmit at least one packet; and transmitting the at least one packet from a storage to the computing node based at least in part on a predefined FPGA program that is stored in the FPGA. The router may be connected between the storage and the computing node.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. With the understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows an illustrative example of a rebooting control system including at least one computing node, at least one router and at least one storage, arranged in accordance with at least some embodiments described herein;

FIG. 2 shows a schematic block diagram illustrating an example architecture for a router, arranged in accordance with at least some embodiments described herein;

FIG. 3 shows an example flow diagram of a process of a router for controlling rebooting process of a computing node, arranged in accordance with at least some embodiments described herein;

FIG. 4 illustrates computer program products that may be utilized to provide a scheme for controlling rebooting process of computing nodes, arranged in accordance with at least some embodiments described herein; and

FIG. 5 is a block diagram illustrating an example computing device that may be utilized to provide a scheme for controlling rebooting process of computing nodes, arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatuses, systems, devices, and computer program products related to schemes for controlling rebooting process of at least one computing node. Technologies are generally described for a router for transmitting a rebooting request and booting information stored in a storage between a computing node and the storage.

In some examples, a router may be connected between a computing node and a storage via a network. For example, the computing node may refer to a laptop computer, a desk top computer, a notebook computer, a mobile device, a personal communication terminal, such as PCS (Personal Communication System), GMS (Global System for Mobile communications), PDC (Personal Digital Cellular), PHS (Personal Handyphone System), or PDA (Personal Digital Assistant). The storage may store booting information or data, which may be necessary for rebooting an operating system of the computing node.

The router may include a router application specific integrated circuit (ASIC) and a field-programmable gate array (FPGA). The router ASIC may perform a normal routing process that includes at least one computational calculating process which is executed between the computing node and storage. The FPGA may perform at least one packet transmission between the computing node and storage, which does not require any computational calculating process.

In some cases, an emergency situation that requires rebooting of the computing node such as a power supply interruption, physical failures or software failures of the computing node may occur. In that case, a user who owns or otherwise exercises control over an embodiment of at least one of the computing node or router may turn on an emergency switch, so that a packet transmission route that connects the computing node, FPGA and storage may be configured. By way of example, but not limitation, the FPGA may connect an Ethernet socket that is connected to the computing node and an Ethernet socket that is connected to the storage. Then, the computing node may transmit a rebooting process request to the storage via the FPGA and the FPGA may simply transmit the rebooting process request to the storage via at least one packet. Further, the FPGA may simply transmit the booting information or data, which is stored in the storage, to the computing node via at least one packet.

Upon completing the rebooting process, the emergency switch may be turned off, so that a packet transmission route that connects the computing node, router ASIC and storage may be configured. Then, the normal routing process that may be necessary for operating at least one application hosted on the computing node may be performed.

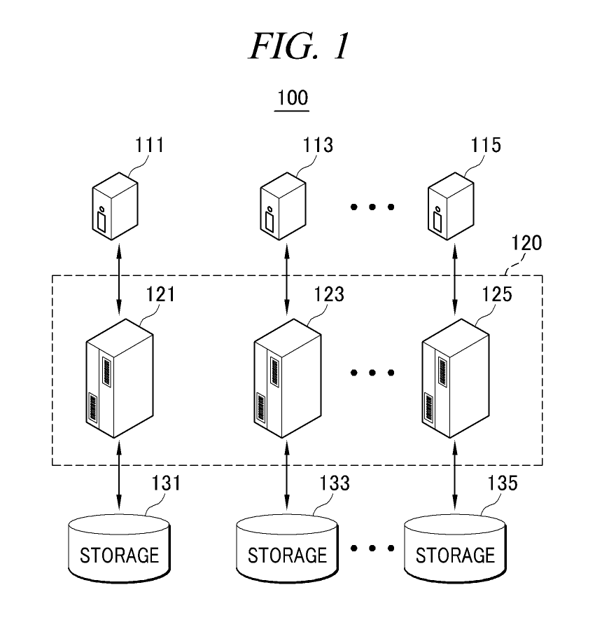

FIG. 1 schematically shows an illustrative example of a rebooting control system 100 including at least one computing node 111, 113 and 115, at least one router 121, 123 and 125, and at least one storage 131, 133 and 135, arranged in accordance with at least some embodiments described herein.

Routers 121, 123 and 125 may be connected to computing nodes 111, 113 and 115, and storages 131, 133 and 135 via a network, respectively. By way of example, but not limitation, the network between computing nodes 111, 113 and 115, routers 121, 123 and 125, and storages 131, 133 and 135 may include all kinds of wireless network such as a mobile radio communication network, a satellite network, a bluetooth, WiBro (Wireless Broadband Internet), Mobile WiMAX, HSDPA (High Speed Downlink Packet Access) or the like.

Further, at least one one-to-one correspondence between one of computing nodes 111, 113 and 115, one of routers 121, 123 and 125, and one of storages 131, 133 and 135 may be established. By way of example, but not limitation, router 121 may be configured to connect an Ethernet socket that is connected to computing node 111 and another Ethernet socket that is connected to storage 131. Router 123 may be configured to connect an Ethernet socket that is connected to computing node 113 and another Ethernet socket that is connected to storage 133. Router 125 may be configured to connect an Ethernet socket that is connected to computing node 115 and another Ethernet socket that is connected to storage 135.

Each of computing nodes 111, 113 and 115 may refer to an apparatus, a device or a server device that may be able to perform data processing via a network. By way of example, but not limitation, each of computing nodes 111, 113 and 115 may include a laptop computer, a desk top computer, a notebook computer, a mobile device, a personal communication terminal, such as PCS (Personal Communication System), GSM (Global System for Mobile communications), PDC (Personal Digital Cellular), PHS (Personal Handyphone System), or PDA (Personal Digital Assistant).

Each of routers 121, 123 and 125 may refer to an apparatus or a device that is connected to two or more data lines from different networks and forwards data packets between computer networks. By way of example, but not limitation, as depicted in FIG. 1, routers 121, 123 and 125 may be included in a cloud system 120. Cloud system 120 may refer to a cloud server or a cloud configuration that provides some type of communications, data storage, data or information processing, or any combination thereof.

Further, each of routers 121, 123 and 125 may be configured to include a router application specific integrated circuit (ASIC) and a field-programmable gate array (FPGA). The router ASIC may be configured to perform a normal routing process that includes at least one computational calculating process which is executed between computing nodes 111, 113 and 115, and storages 131, 133 and 135 for operating at least one application hosted on computing nodes 111, 113 and 115. Further, the FPGA may be configured to perform at least one packet transmission between computing nodes 111, 113 and 115, and storages 131, 133 and 135, which does not require any computational calculating process.

Each of storage 131, 133 and 135 may refer to an apparatus, a device or a server device that may store data or information. By way of example, but not limitation, storages 131, 133 and 135 may store booting information or data, which is necessary for rebooting an operating system of each computing node 111, 113 and 115.

Although FIG. 1 illustrates that three computing nodes 111, 113 and 115 are connected to three storages 131, 133 and 135 via three routers 121, 123 and 125, one skilled in the art will appreciate that any number of one-to-one correspondence between a computing node, a router and a storage may be configured.

Hereinafter, for simplicity of explanation, FIG. 1 will be explained with reference to computing node 111, router 121 and storage 131. However, it will be understood by a person of ordinary skill in the art that the same process may be performed by and applied to the remaining computing nodes 113 and 115, routers 123 and 125, and storages 133 and 135.

In some embodiments, if an emergency situation that requires rebooting of computing node 111, such as a power supply interruption, physical failures or software failures of computing node 111, occurs, a user or administrator who owns or otherwise exercises control over an embodiment of at least one of computing node 111 or router 121 may turn on an emergency switch. By way of example, but not limitation, the emergency switch may refer to a mechanical switch or a remote controller that is operatively connected to router 121 via a wired or wireless network. Then, router 121 may be configured to switch from the router ASIC to the FPGA in router 121 as a data packet transmission passage, so that the FPGA of router 121 may be enabled to transmit at least one data packet between computing node 111 and storage 131. By way of example, router 121 may be configured to connect the Ethernet socket that is connected to computing node 111 and the Ethernet socket that is connected to storage 131, so that a packet transmission route that includes computing node 111, the FPGA of router 121 and storage 131 may be configured.

Further, router 121 may be configured to receive a signal that initiates a rebooting process of computing node 111. By way of example, but not limitation, router 121 may be configured to receive the rebooting process start signal from a device of an administrator who owns or otherwise exercises control over cloud system 120. In some other examples, the rebooting process start signal may be transmitted from the device of the administrator of cloud system 120 to computing node 111 and computing node 111 may transmit the received rebooting process start signal to router 121.

Further, computing node 111 may be configured to transmit a rebooting request message (i.e., the rebooting process start signal) to storage 131. In some embodiments, between the Ethernet socket of computing node 111 and the Ethernet socket of storage 131, router 121 may transmit the rebooting request message via at least one data packet from computing node 111 to storage 131 based at least in part on a predefined FPGA program. The predefined FPGA program may be stored in the FPGA of router 121. The predefined FPGA program may define the one-to-one correspondence between computing node 111 and storage 131. By way of example, but not limitation, an identifier of computing node 111, such as a MAC address of computing node 111, may be stored in the predefined FPGA program in association with an identifier of storage 131, such as a MAC address of storage 131.

In some embodiments, router 121 may be configured to store computing node information regarding multiple computing nodes, which includes identifiers of the multiple computing nodes, in a memory that is operatively coupled to router 121. Further, router 121 may be configured to store storage information regarding multiple storages, which includes identifiers of the multiple storages, in the same or other memory that is operatively coupled to router 121. Router 121 may be further configured to generate the predefined FPGA program based at least in part on the stored computing node information and storage information. Then, router 121 may be configured to transmit the generated predefined FPGA program to the FPGA in router 121 and write the predefined FPGA program into the FPGA.

In some other embodiments, router 121 may be configured to receive the predefined FPGA program from an FPGA program generator (not shown in FIG. 1) that is communicatively coupled to router 121. The FPGA program generator may be configured to store the computing node information and storage information in at least one memory that is operatively coupled to the FPGA program generator. The FPGA program generator may be further configured to generate the predefined FPGA program based at least in part on the stored computing node information and storage information and transmit the generated predefined FPGA program to router 121 via a network. Then, router 121 may be configured to receive the predefined FPGA program from the FPGA program generator and transmit the received FPGA program to the FPGA in router 121 and then, write the predefined FPGA program into the FPGA.

In some embodiments, storage 131 may be configured to receive the rebooting request message from computing node 111 via router 121. Storage 131 may be further configured to derive the booting information or data, which is necessary for rebooting an operating system of computing node 111. Then, storage 131 may be further configured to transmit the booting information or data to computing node 111 in response to the receipt of the rebooting request message. By way of example, between the Ethernet socket of computing node 111 and the Ethernet socket of storage 131, router 121 may transmit the booting information or data via at least one data packet from storage 131 to computing node 111 based at least in part on the predefined FPGA program that is stored in the FPGA of router 121.

Upon receiving the booting information or data, a rebooting process of the operating system of computing node 111 may be performed and the emergency situation may be cleared. Then, the user or administrator of at least one of computing node 111 or router 121 may turn off the emergency switch. Then, router 121 may be configured to switch from the FPGA to the router ASIC as the data packet transmission passage, so a packet transmission route that connects computing node 111, the router ASIC of router 121 and storage 131 may be configured. Then, normal routing processes that may be necessary for operating at least one application hosted on computing node 111 may be performed.

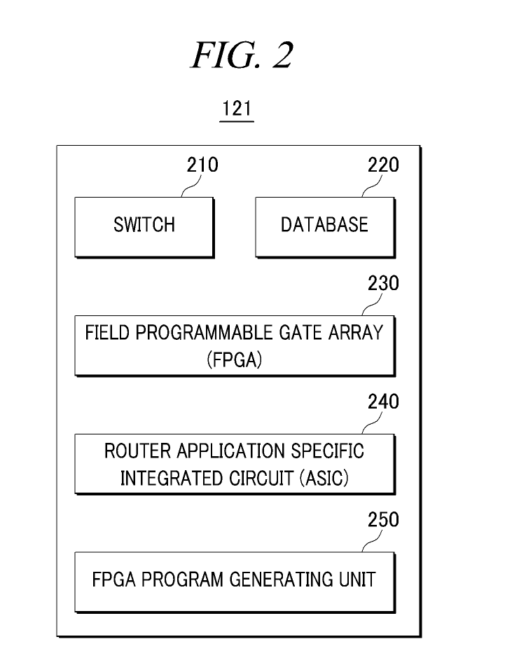

FIG. 2 shows a schematic block diagram illustrating an example architecture for a router 121, arranged in accordance with at least some embodiments described herein. As depicted in FIG. 2, router 121 may include a switch 210, a database 220, a field programmable gate array (FPGA) 230, a router application specific integrated circuit (ASIC) 240, and an FPGA program generating unit 250. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or virtually any combination thereof. In that regard, one or more of switch 210, database 220, field programmable gate array (FPGA) 230, router application specific integrated circuit (ASIC) 240, and FPGA program generating unit 250 may be included in an instance of an application hosted on router 121.

Switch 210 may be configured to receive a signal that initiates a rebooting process of computing node 111. By way of example, but not limitation, switch 210 may be configured to receive the rebooting process start signal from a device of an administrator who owns or otherwise exercises control over cloud system 120 or computing node 111.

Further, switch 210 may be configured to switch from router ASIC 240 to FPGA 230 as a data packet transmission passage, so that FPGA 230 may be enabled to transmit at least one data packet between computing node 111 and storage 131. By way of example, switch 210 may be configured to connect an Ethernet socket that is connected to computing node 111, FPGA 230, and an Ethernet socket that is connected to storage 131, so that a packet transmission route that includes computing node 111, FPGA 230 and storage 131 may be configured.

Further, switch 210 may be configured to switch from FPGA 230 to router ASIC 240 as the data packet transmission passage, when the rebooting process of computing node 111 is completed. By way of example, but not limitation, switch 210 may be configured to connect the Ethernet socket that is connected to computing node 111, router ASIC 240, and the Ethernet socket that is connected to storage 131, so that a packet transmission route that includes computing node 111, router ASIC 240 and storage 131 may be configured.

Database 220 may be configured to store a predefined FPGA program that defines at least one one-to-one correspondence between at least one computing node and at least one storage. Further, database 220 may be configured to store computing node information regarding multiple computing nodes, which includes identifiers of the multiple computing nodes such as a MAC address of each computing node. Further, database 220 may be configured to store storage information regarding multiple storages, which includes identifiers of the multiple storages such as a MAC address of each storage. By way of example, in database 220, each MAC address of the multiple computing nodes is stored in the predefined FPGA program in association with each MAC address of the multiple storages. Further, database 220 may be configured to store algorithms or operations for operating and/or controlling router 121.

FPGA 230 may be configured to transmit the rebooting process start signal from computing node 111 to storage 131 via at least one data packet based at least in part on the predefined FPGA program. By way of example, but not limitation, FPGA 230 may be configured to transmit the rebooting process start signal from the Ethernet socket of computing node 111 to the Ethernet socket of storage 131.

FPGA 230 may be further configured to transmit booting information or data that is necessary for rebooting an operating system of computing node 111. In some embodiments, storage 131 may be configured to transmit the booting information or data to computing node 111 in response to the receipt of the rebooting process start signal (i.e., the rebooting request message). Between the Ethernet socket of computing node 111 and the Ethernet socket of storage 131, FPGA 230 may be configured to transmit the booting information or data via at least one data packet from storage 131 to computing node 111 based at least in part on the predefined FPGA program.

Further, in some embodiments, FPGA 230 may be configured to receive the predefined FPGA program from FPGA program generating unit 250. In some other embodiments, FPGA 230 may be configured to receive the predefined FPGA program from an FPGA program generator that is operatively coupled to router 121. Then, FPGA 230 may be configured to write and store the received predefined FPGA program into FPGA 230.

Router ASIC 240 may be configured to perform at least one normal routing process that includes at least one computational calculating process which is executed between computing node 111 and storage 131 for operating at least one application hosted on computing node 111.

FPGA program generating unit 250 may be configured to generate the predefined FPGA program based at least in part on the computing node information and storage information, which are stored in database 220. FPGA program generating unit 250 may be further configured to transmit the generated predefined FPGA program to FPGA 230.

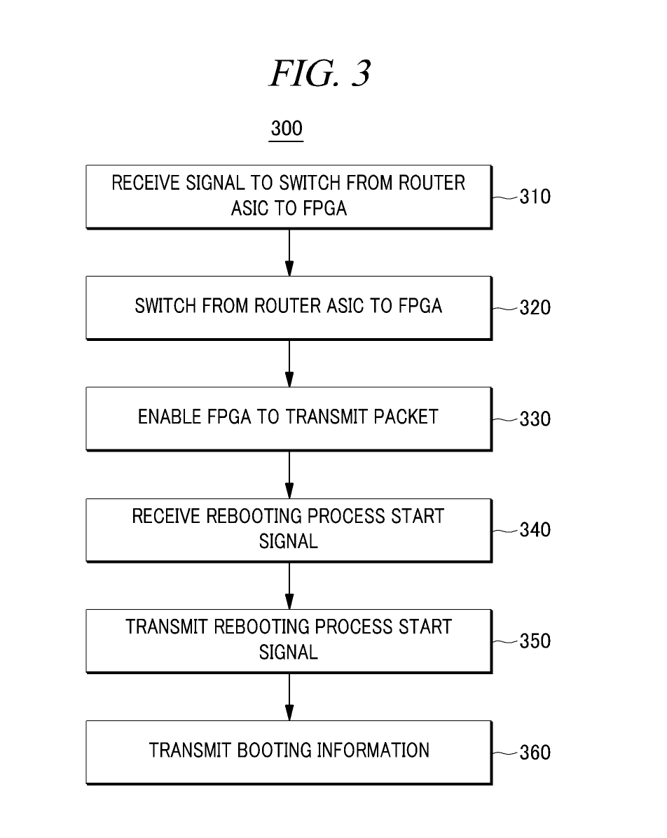

FIG. 3 shows an example flow diagram of a process 300 of a router 121 for controlling rebooting process of a computing node 111, arranged in accordance with at least some embodiments described herein. The method in FIG. 3 may be implemented in communication environments 100 including computing node 111, router 121 and storage 131, as illustrated in FIG. 1. An example process may include one or more operations, actions, or functions as illustrated by one or more blocks 310, 320, 330, 340, 350 and/or 360. Although illustrated as discrete blocks, various blocks may be divided into additional blocks, combined into fewer blocks, or eliminated, depending on the desired implementation. Processing may begin at block 310.

At block 310 (Receive Signal to Switch from Router ASIC to FPGA), router 121 may be configured to receive a signal to switch from a router ASIC to an FPGA in router 121 as a data packet transmission passage. The router ASIC may be configured to perform a normal routing process that includes at least one computational calculating process which is executed between computing node 111 and storages 131 for operating at least one application hosted on computing node 111. Further, the FPGA may be configured to perform at least one packet transmission between computing node 111 and storage 131, which does not require any computational calculating process. In some embodiments, if an emergency situation that requires rebooting of computing node 111 such as a power supply interruption, physical failures or software failures of computing node 111 occurs, a user or administrator who owns or otherwise exercises control over an embodiment of at least one of computing node 111 or router 121 turns on an emergency switch, which is operatively coupled to router 121. By way of example, but not limitation, the emergency switch may refer to a mechanical switch or a remote controller that is operatively connected to router 121 via a wired or wireless network. Router 121 may be configured to receive, from the emergency switch, or a device of the administrator or another control device which is operatively coupled to the emergency switch, the signal to switch from the router ASIC to the FPGA, when the user or administrator turns on the emergency switch. Processing may proceed from block 310 to block 320.

At block 320 (Switch from Router ASIC to FPGA), router 121 may be configured to switch from the router ASIC to the FPGA in router 121 as the data packet transmission passage. Router 121 may be configured to change the data packet transmission passage from via the router ASIC to via the FPGA, when router 121 receives the signal to switch from the router ASIC to the FPGA at block 310. Processing may proceed from block 320 to block 330.

At block 330 (Enable FPGA to Transmit Packet), router 121 may be configured to enable the FPGA of router 121 to transmit data packet between computing node 111 and storage 131. By way of example, router 121 may be configured to connect an Ethernet socket that is connected to computing node 111 and an Ethernet socket that is connected to storage 131, so that a packet transmission route that includes computing node 111, the FPGA of router 121 and storage 131 may be configured. Processing may proceed from block 330 to block 340.

At block 340 (Receive Rebooting Process Start Signal), router 121 may be configured to receive a signal that initiates a rebooting process of computing node 111. By way of example, but not limitation, router 121 may be configured to receive the rebooting process start signal from a device of an administrator who owns or otherwise exercises control over cloud system 120 or computing node 111. Processing may proceed from block 340 to block 350.

At block 350 (Transmit Rebooting Process Start Signal), router 121 may be configured to transmit the rebooting process start signal from computing node 111 to storage 131 via at least one data packet based at least in part on a predefined FPGA program. By way of example, but not limitation, router 121 may be configured to transmit the rebooting process start signal to storage 131 through the packet transmission route, which includes computing node 111, the FPGA of router 121 and storage 131.

The predefined FPGA program may define one-to-one correspondences between computing nodes and storages. By way of example, but not limitation, an identifier of computing node 111, such as a MAC address of computing node 111, may be stored in the predefined FPGA program in association with an identifier of storage 131, such as a MAC address of storage 131.

In some embodiments, router 121 may be configured to store computing node information regarding multiple computing nodes, which includes identifiers of the multiple computing nodes, in a memory that is operatively coupled to router 121. Further, router 121 may be configured to store storage information regarding multiple storages, which includes identifiers of the multiple storages, in the same or other memory that is operatively coupled to router 121. Router 121 may be further configured to generate the predefined FPGA program based at least in part on the stored computing node information and storage information. Then, router 121 may be configured to transmit the generated predefined FPGA program to the FPGA in router 121 and write the predefined FPGA program into the FPGA.

In some other embodiments, router 121 may be configured to receive the predefined FPGA program from an FPGA program generator that is communicatively coupled to router 121. Then, router 121 may be configured to transmit the received FPGA program to the FPGA in router 121 and write the predefined FPGA program into the FPGA. Processing may proceed from block 350 to block 360.

At block 360 (Transmit Booting Information), router 121 may be configured to transmit booting information or data that is necessary for rebooting an operating system of computing node 111 from storage 131 to computing node 111. In some embodiments, storage 131 may be configured to transmit the booting information or data to computing node 111 in response to the receipt of the rebooting process start signal. Between the Ethernet socket of computing node 111 and the Ethernet socket of storage 131, router 121 may be configured to transmit the booting information or data via at least one data packet from storage 131 to computing node 111 based at least in part on the predefined FPGA program.

Then, a rebooting process of the operating system of computing node 111 may be performed and the emergency situation may be cleared. Then, the user or administrator of at least one of computing node 111 or router 121 may turn off the emergency switch. Router 121 may be configured to switch from the FPGA to the router ASIC as the data packet transmission passage, so a packet transmission route that connects computing node 111, the router ASIC of router 121 and storage 131 may be configured. Then, normal routing processes that may be necessary for operating at least one application hosted on computing node 111 may be performed.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

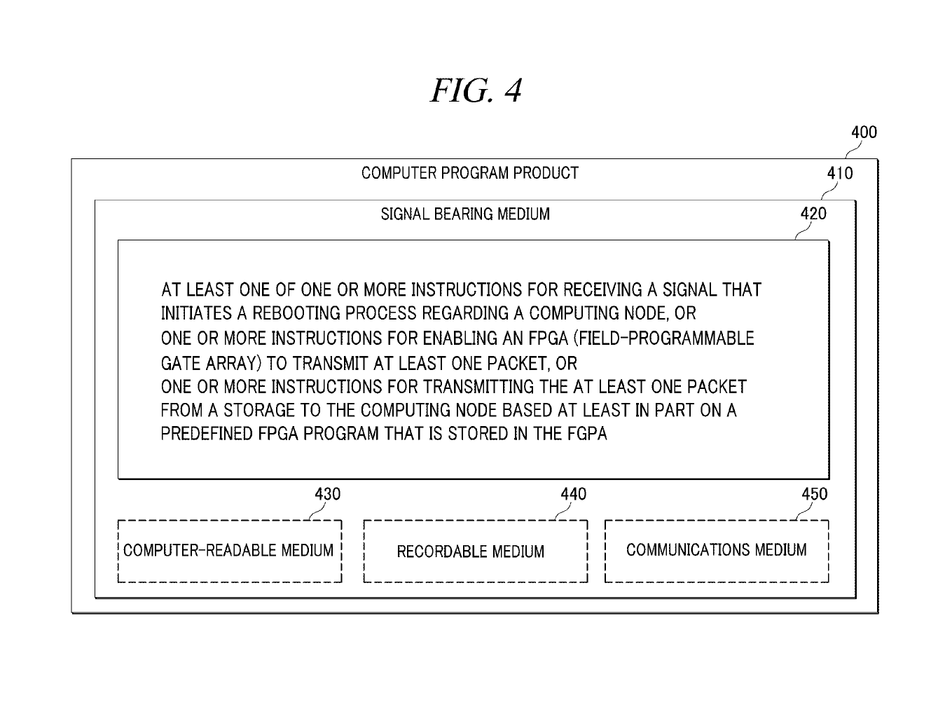

FIG. 4 illustrates computer program products that may be utilized to provide a scheme for controlling rebooting process of computing nodes, arranged in accordance with at least some embodiments described herein. Program product 400 may include a signal bearing medium 410. Signal bearing medium 410 may include one or more instructions 420 that, when executed by, for example, a processor, may provide the functionality described above with respect to FIGS. 1-3. By way of example, but not limitation, instructions 420 may include: one or more instructions for receiving a signal that initiates a rebooting process regarding a computing node; one or more instructions for enabling an FPGA (Field-Programmable Gate Array) to transmit at least one packet; one or more instructions for transmitting the at least one packet from a storage to the computing node based at least in part on a predefined FPGA program that is stored in the FPGA. Thus, for example, referring to FIG. 3, router 121 may undertake one or more of the blocks shown in FIG. 3 in response to instructions 420.

In some implementations, signal bearing medium 410 may encompass a computer-readable medium 430, such as, but not limited to, a hard disk drive, a CD, a DVD, a digital tape, memory, etc. In some implementations, signal bearing medium 410 may encompass a recordable medium 440, such as, but not limited to, memory, read/write (R/W) CDs, R/W DVDs, etc. In some implementations, signal bearing medium 410 may encompass a communications medium 450, such as, but not limited to, a digital and/or an analog communication medium (e.g., a fiber optic cable, a waveguide, a wired communications link, a wireless communication link, etc.). Thus, for example, program product 400 may be conveyed to one or more modules of router 121 by an RF signal bearing medium 420, where the signal bearing medium 420 is conveyed by a wireless communications medium 450 (e.g., a wireless communications medium conforming with the IEEE 802.11 standard).

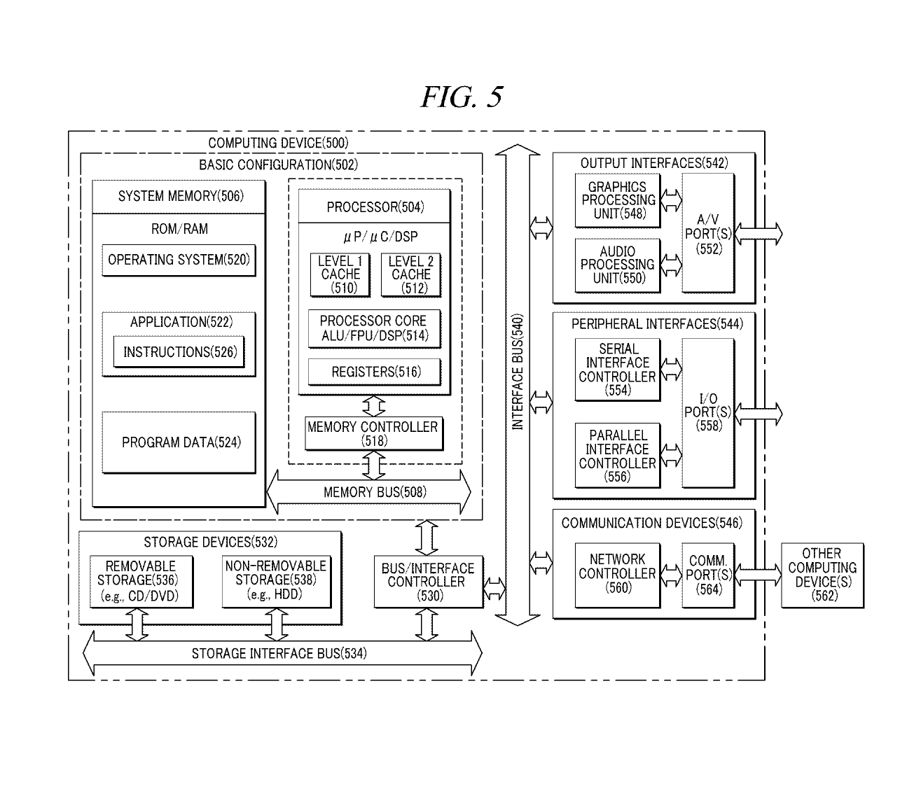

FIG. 5 is a block diagram illustrating an example computing device that may be utilized to provide a scheme for controlling rebooting process of computing nodes, arranged in accordance with at least some embodiments described herein. In these examples, elements of computing device 500 may be arranged or configured for a device. In a very basic configuration 502, computing device 500 typically includes one or more processors 504 and a system memory 506. A memory bus 508 may be used for communicating between processor 504 and system memory 506.

Depending on the desired configuration, processor 504 may be of any type including but not limited to a microprocessor (μP), a microcontroller (μC), a digital signal processor (DSP), or any combination thereof. Processor 504 may include one more levels of caching, such as a level one cache 510 and a level two cache 512, a processor core 514, and registers 516. An example processor core 514 may include an arithmetic logic unit (ALU), a floating point unit (FPU), a digital signal processing core (DSP Core), or any combination thereof. An example memory controller 518 may also be used with processor 504, or in some implementations memory controller 518 may be an internal part of processor 504.

Depending on the desired configuration, system memory 506 may be of any type including but not limited to volatile memory (such as RAM), nonvolatile memory (such as ROM, flash memory, etc.) or any combination thereof. System memory 506 may include an operating system 520, an application 522, and program data 524. Application 522 may include instructions 526 that may be arranged to perform the functions as described herein including the actions described with respect to the router architecture as shown in FIG. 2 or including the actions described with respect to the flow charts shown in FIG. 3. In some examples, application 522 may be arranged to operate with program data 524 on an operating system 520 such that the schemes for controlling rebooting process of computing nodes as described herein may be provided.

Computing device 500 may have additional features or functionality, and additional interfaces to facilitate communications between basic configuration 502 and any required devices and interfaces. For example, a bus/interface controller 530 may be used to facilitate communications between basic configuration 502 and one or more data storage devices 532 via a storage interface bus 534. Data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 506, removable storage devices 536 and non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of computing device 500.

Computing device 500 may also include an interface bus 540 for facilitating communication from various interface devices (e.g., output devices 542, peripheral interfaces 544, and communication devices 546) to basic configuration 502 via bus/interface controller 530. Example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 546 includes a network controller 560, which may be arranged to facilitate communications with one or more other computing devices 562 over a network communication link via one or more communication ports 564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 500 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method performed under control of a router connected between a storage and a computing node, comprising:
receiving a signal that initiates a rebooting process of the computing node;
enabling an FPGA (Field-Programmable Gate Array) to transmit at least one packet;
switching from a router ASIC (Application Specific Integrated Circuit) to the FPGA based on receiving the signal that initiates the rebooting process; and
transmitting the at least one packet from the storage to the computing node based at least in part on a predefined FPGA program that is stored in the FPGA.

2. The method of claim 1, further comprising:
switching from a router ASIC (Application Specific Integrated Circuit) to the FPGA,
wherein the router ASIC performs a normal routing process including at least one calculating process.

3. The method of claim 1, wherein the predefined FPGA program defines a one-to-one correspondence between the storage and the computing node.

4. The method of claim 3, wherein a MAC address of the storage is associated with a MAC address of the computing node in the predefined FPGA program.

5. The method of claim 3, further comprising:
generating the predefined FPGA program;
transmitting the predefined FPGA program to the FPGA; and
writing the predefined FPGA program into the FPGA.

6. The method of claim 3, further comprising:
receiving the predefined FPGA program; and
writing the predefined FPGA program into the FPGA.

7. The method of claim 1, wherein the storage is configured to store booting information of an operating system of the computing node, and
wherein the booting information is transmitted via the at least one packet from the storage to the computing node.

8. The method of claim 1, wherein the transmitting is performed between an Ethernet socket of the storage and an Ethernet socket of the computing node.

9. A router connected between a storage and a computing node, the router comprising:
an FPGA (Field-Programmable Gate Array) configured to transmit at least one packet from the storage to the computing node based at least in part on a predefined FPGA program that is stored in the FPGA; and
a switch configured to:
receive a signal that initiates a rebooting process of the computing node,
switch from a router ASIC (Application Specific Integrated Circuit) to the FPGA based on receiving the signal that initiates the rebooting process, and
enable the FPGA to transmit the at least one packet.

10. The router of claim 9, further comprising:
a router ASIC (Application Specific Integrated Circuit) configured to perform a normal routing process that includes at least one calculating process.

11. The router of claim 9, wherein the predefined FPGA program defines a one-to-one correspondence between the storage and the computing node.

12. The router of claim 11, wherein a MAC address of the storage is associated with a MAC address of the computing node in the predefined FPGA program.

13. The router of claim 11, further comprising:
an FPGA program generating unit configured to:
generate the predefined FPGA program, and
transmit the generated predefined FPGA program to the FPGA,
wherein the FPGA is further configured to:
receive the predefined FPGA program from the FPGA program generating unit, and
write the received predefined FPGA program into the FPGA.

14. The router of claim 13, further comprising:
a database configured to store storage information regarding a plurality of storages and computing node information regarding a plurality of computing nodes,
wherein the FPGA program generating unit is configured to generate, based on the storage information and the computing node information, the predefined FPGA program that defines a plurality of one-to-one correspondences between each of the plurality of storages and each of the plurality of computing nodes.

15. The router of claim 11, wherein the FPGA is further configured to:
receive the predefined FPGA program from a FPGA program generator that is operatively coupled to the router, and
write the received predefined FPGA program into the FPGA.

16. The router of claim 9, wherein the storage is configured to store booting information of an operating system of the computing node, and
wherein the FPGA is further configured to transmit the booting information from the storage to the computing node via the at least one packet.

17. The router of claim 9, wherein the FPGA is further configured to transmit the at least one packet from an Ethernet socket of the storage to an Ethernet socket of the computing node.

18. A computer-readable storage medium having stored thereon computer-executable instructions that, in response to execution, cause a router to perform operations, comprising:
receiving a signal that initiates a rebooting process regarding a computing node;
enabling an FPGA (Field-Programmable Gate Array) to transmit at least one packet;
switching from a router ASIC (Application Specific Integrated Circuit) to the FPGA based on receiving the signal that initiates the rebooting process; and
transmitting the at least one packet from a storage to the computing node based at least in part on a predefined FPGA program that is stored in the FPGA,
wherein the router is connected between the storage and the computing node.

19. The computer-readable storage medium of claim 18,
wherein the router ASIC performs a normal routing process including at least one calculating process.

20. The computer-readable storage medium of claim 19, wherein the storage is configured to store booting information of an operating system of the computing node, and
wherein the booting information is transmitted via the at least one packet from the storage to the computing node.
